(19) United States
(12) Patent Application Publication
(10) Pub. No.: US 2019/0316528 A1
(43) Pub. Date: Oct. 17, 2019

(54) METHOD AND SYSTEM FOR CONTROLLING AN INTERNAL COMBUSTION ENGINE II

(71) Applicant: SCANIA CV AB, Södertälje (SE)

(72) Inventors: John GAYNOR, Hölö (SE); Torbjörn ELIASSEN, Nykvarn (SE); Andreas DAHL, Nyköping (SE)

(73) Assignee: SCANIA CV AB, Södertälje (SE)

(21) Appl. No.: 16/343,419

(22) PCT Filed: Oct. 11, 2017
(86) PCT No.: PCT/SE2017/050998

§ 371 Date: Apr. 19, 2019

(30) Foreign Application Priority Data
Oct. 19, 2016 (SE) 1651368-1

(51) Int. Cl. F02D 13/02; F02D 41/00

(52) U.S. Cl. CPC F02D 13/0261; F02B 27/0242; F02D 41/0007

(57) ABSTRACT

The present invention relates to a method for controlling a compression-ignition internal combustion engine, having at least one combustion chamber, wherein intake of air to said combustion chamber is controlled using an intake valve, and evacuation of said combustion chamber is controlled using an exhaust valve. The method comprises: controlling opening of said intake valve and closing of said exhaust valve in dependence of the position of a reciprocating member in said combustion chamber, wherein opening of said intake valve and closing of said exhaust valve, respectively, in relation to the position of said reciprocating member is individually controllable, and controlling opening and closing in relation to the position of said reciprocating member on the basis of a first control parameter, wherein said opening and closing of said intake valve and exhaust valve, respectively, are controlled such that an actual value of said control parameter is adjusted towards a desired value.

### CROSS-REFERENCE TO RELATED APPLICATION(S)

This application is a national stage application (filed under 35 § U.S.C. 371) of PCT/SE2017/050998, filed Oct. 11, 2017 of the same title, which, in turn, claims priority to Swedish Application No. 1651368-1 filed Oct. 19, 2016; the contents of each of which are hereby incorporated by reference.

### FIELD OF THE INVENTION

The present invention relates to combustion processes, and in particular to a method and system for controlling an internal combustion engine. The present invention also relates to a vehicle, as well as a computer program and a computer program product that implement the method according to the invention.

### BACKGROUND OF THE INVENTION

With regard to vehicles in general, and at least to some extent heavy/commercial vehicles such as trucks, buses and the like, there is constantly ongoing research and development with regard to increasing fuel efficiency and reducing exhaust emissions.

This is often at least partly due to growing governmental concern in pollution and air quality, e.g. in urban areas, which has also led to the adoption of various emission standards and rules in many jurisdictions.

These emission standards often consist of requirements that define acceptable limits for exhaust emissions of vehicles being provided with internal combustion engines. For example, the exhaust levels of e.g. nitric oxides (NOₓ), hydrocarbons (HC), carbon monoxide (CO) and particles are regulated for most kinds of vehicles in these standards.

Undesired emission of substances can be reduced by reducing fuel consumption and/or through the use of aftertreatment (purifying) of the exhaust gases that results from the combustion process.

Exhaust gases from the internal combustion engine can, for example, be treated through the use of a catalytic process. There exist various kinds of catalytic converters, where different types can be used for different kinds of fuel and/or for treatment of different kinds of substances occurring in the exhaust gas stream. For example, a common kind of catalytic converters that are used in particular for reduction of nitric oxides, NOₓ, is Selective Catalytic Reduction (SCR) catalytic converters.

Catalytic converters being used for aftertreatment of an exhaust gas stream in general have in common that at least a minimum temperature must be maintained in the catalytic converter in order to ensure that desired reactions occur. Furthermore, the catalytic converters may also be temperature sensitive in the regard that too high temperatures may be damaging.

Furthermore, there is a general tendency towards down-speeding of internal combustion engines in order to further reduce fuel consumption. High loads at low engine speeds, however, may impose additional challenges on combustion engine operation.

### SUMMARY OF THE INVENTION

It is an object of the present invention to provide a method and system that controls operation of a compression-ignition internal combustion engine, and, in particular, improved combustion chamber scavenging. For example, an intake valve and an exhaust valve can be controlled to obtain scavenging of a combustion chamber adapted to current operating conditions of the internal combustion engine. This object is achieved by a method according to claim 1.

According to the present invention, it is provided a method for controlling a compression-ignition internal combustion engine, said internal combustion engine having at least one combustion chamber, wherein intake of air to said combustion chamber is controlled using an intake valve, and wherein evacuation of said combustion chamber is controlled using an exhaust valve. The method includes:
controlling opening of said intake valve and closing of said exhaust valve in dependence of the position of a reciprocating member in said combustion chamber, wherein opening of said intake valve and closing of said exhaust valve, respectively, in relation to the position of said reciprocating member is individually controllable, and
controlling opening and closing of said valves in relation to the position of said reciprocating member on the basis of a first control parameter, wherein said opening and closing of said intake valve and exhaust valve, respectively, are controlled such that an actual value of said control parameter is adjusted towards a desired value of said control parameter.

Said reciprocating member may, for example, be a reciprocating piston in said combustion chamber. The internal combustion engine may further comprise a fixed geometry turbocharger.

Exhaust gases arising from combustion in a combustion chamber of an internal combustion engine are evacuated in order to again fill the combustion chamber with air or air/fuel of a following combustion. This process of evacuating exhaust gases and filling the combustion chamber with air or air/fuel of a following combustion is called scavenging. Scavenging is performed through the use of one or more exhaust valves, which open a passage to an exhaust manifold, and one or more intake valves that open a passage to an intake conduit for intake of air for use in combustion.

The exhaust gases resulting from combustion are in general treated prior to being released into the surroundings, such as surroundings of a vehicle. There are various ways of treating these exhaust gases in order to reduce harmful emissions into the surroundings of the vehicle. For example, it is common, at least with regard to heavy/commercial vehicles, that nitric oxides NOₓ are reduced.

The generation of nitric oxides NOₓ is highly temperature dependent, where higher amounts are generated at higher combustion temperatures. The amount of nitric oxides NOₓ in the exhaust gas stream may be reduced prior to the exhaust gas stream being released into the surroundings of the vehicle, for example using a Selective Catalytic Reduction (SCR) catalytic converter. Such reduction may not always be sufficient, and it is also possible to reduce the nitric oxides by recirculating part of the exhaust gases (commonly denoted EGR) in order to reduce the maximum temperature that arises during combustion, and therefore also the amount of nitric oxides NOₓ being generated during the combustion.

There exist, however, systems where aftertreatment is capable of reducing nitric oxides to a satisfactory extent using e.g. an SCR catalytic converter without the need for EGR recirculation. The present invention relates in particular to systems of this kind, although being applicable also in systems utilizing EGR.

Aftertreatment components, such as perhaps in particular SCR catalytic converters, are oftentimes relatively temperature sensitive. For example, if a temperature of the exhaust gases produced by the internal combustion engine reaches too high levels, the hot exhaust gases may damage aftertreatment components such as e.g. SCR catalytic converters. Since there is a general tendency towards down-speeding and thereby operation of internal combustion engines at high loads at low engine speeds, exhaust temperatures may increase due to lesser amounts of cold air being supplied to the combustion and following aftertreatment. This may be partly due to the lower engine speeds being used, but also due to insufficient evacuation of hot exhausts from the combustion engine, thereby reducing the possibility to supply air to the combustion, resulting in less optimal scavenging.

With regard to scavenging, this essentially means that following a power stroke, an exhaust valve is opened on the piston return stroke towards top dead centre (TDC) to evacuate the exhaust gases prior to a following intake of air.

According to the present invention, it is provided a method for controlling a compression-ignition internal combustion engine in a manner utilizing controlled scavenging e.g. in situations of the above kind. The invention may also provide additional advantages, or possibilities, by varying operation of the intake valve and exhaust valve in dependence of the combustion engine operating conditions. For example, the invention can be used to control exhaust gas temperature and to control internal combustion engine efficiency using different degrees of scavenging.

According to the invention it is provided a method where opening of the intake valve, and closing of the exhaust valve, respectively, are individually controlled in dependence of the position of a reciprocating member such as piston. That is, the intake valve may be controlled to be opened at varying piston positions, and hence earlier or later in relation to e.g. when a piston reaches top dead centre (TDC). Correspondingly, the closing of the exhaust valve can also be controlled to occur at varying piston positions, and hence earlier or later in relation to when e.g. a piston reaches TDC.

Consequently, according to the invention, opening of the intake valve and closing of the exhaust valve, respectively, can for different situations be independently controlled and performed at different positions of, and in variable dependence of the position of, a piston.

According to the invention, opening and closing of the intake valve and exhaust valve, respectively, are controlled in relation to the position of said reciprocating member on the basis of a first control parameter, wherein an actual value of said control parameter is adjusted towards a desired value of said control parameter by varying closing of the exhaust valve and/or opening of the intake valve according to the above. For example, air/fuel ratio and/or the degree to which exhaust residuals from combustion cycle remain in the combustion chamber to a following combustion cycle may be used as control parameter according to the invention.

A high degree of freedom in the control of opening and closing of intake valve and exhaust valve may be provided, and the intake valve and exhaust valve may be controllable such that at least in one mode of operation both intake valve and exhaust valve are simultaneously open, thereby allowing a flow of intake air through the combustion chamber while both valves are open. The period, such as a portion of a combustion cycle, during which both valves are simultaneously open may also be controllable.

Hence, according to at least one mode of operation, the intake valve is opened prior to closing the exhaust valve so that intake air passes through the combustion chamber and simultaneously mixes with and evacuates exhaust residuals, i.e. a portion of the exhaust gases remaining in the combustion chamber following an exhaust stroke, so that exhaust residuals remaining in the combustion chamber are substantially reduced. This facilitates evacuation of the combustion chamber so that hot exhausts are evacuated to a higher extent. This improves scavenging since the intake air reduces combustion residuals by facilitating evacuation thereof, and has a cooling effect on the combustion chamber/combustion residuals possibly still remaining in the combustion chamber.

When an efficiency of said internal combustion engine is to be increased, the desired value of the control parameter can be controlled such that when controlling an actual value of said control parameter towards said desired value the opening of said intake valve is advanced and/or closing of said exhaust valve is retarded in relation to the position of the reciprocating member in said combustion chamber. In this way, air may be allowed, or be allowed for a longer period of time, to pass through the combustion chamber when both valves are open to thereby cool exhaust residuals and also evacuate exhaust residuals to a higher extent.

Furthermore, when it is desired to increase an exhaust gas temperature the desired value of said control parameter can be adjusted such that when controlling an actual value of said control parameter towards said desired value, closing of said exhaust valve is advanced and/or opening of said intake valve is retarded in relation to the position of the reciprocating member in said combustion chamber. In this way, an overlap in opening time can be reduced, and/or the valves be controlled such that there is no overlap, thereby reducing passage of cold air through the combustion chamber and increasing the amount of hot exhaust residuals remaining in the combustion chamber.

The control parameter can, for example, be a desired air/fuel ratio, which e.g. may be expressed in terms of lambda. An actual air/fuel ratio can be determined, and when the actual air/fuel ratio differs from the desired air/fuel ratio, the exhaust and intake valves can be controlled such that the actual air/fuel ratio is adjusted towards the desired air/fuel ratio. For example, when the actual air/fuel ratio is below the desired air/fuel ratio, closing of the exhaust valve can be retarded and/or opening of the intake valve be advanced in relation to the position of said reciprocating member in said combustion chamber so that e.g. air is allowed to pass through the combustion chamber while both valves are open and/or the period when both valves are open is being prolonged.

Conversely, when the actual air/fuel ratio is above a desired air/fuel ratio, closing of the exhaust valve can be advanced and/or opening of the intake valve be retarded in relation to the position of said reciprocating member in said combustion chamber to reduce the amount of air passed through simultaneously open valves, or increase residuals remaining in the combustion chamber to reduce intake of fresh air.

The control parameter may also be a representation of remaining exhaust residuals in the combustion chamber, where, when an exhaust gas temperature is to be increased, the desired value of remaining exhaust residuals can be adjusted such that the desired exhaust residuals increase when controlling the actual value of said exhaust residuals towards said desired value. In addition, when an efficiency of said internal combustion engine is to be increased, the desired value of remaining exhaust residuals can be controlled such that the desired exhaust residuals reduce when controlling the actual value of said exhaust residuals towards said desired value.

With regard to the desired values of the control parameters, such as e.g. air/fuel ratio and remaining exhaust residuals, such desired control parameters are in general dependent on factors/parameters such as internal combustion engine load, and/or rotational speed of the combustion engine and/or ambient temperature. For example, the desired values of the air/fuel ratio in the control according to embodiments of the invention may be determined from current load and rotational speed of the internal combustion engine. Such desired values are oftentimes known to the person skilled in the art, i.e. it is known at which air/fuel ratio the internal combustion engine operates as desired for a given operating point. Such desired values e.g. may be described as a mathematical function or e.g. be represented by a map containing desired air/fuel ratios for various load/rotational speed combinations.

Depending on the particular result to be achieved by the control according to the embodiments of the invention, there may exist various desired values of e.g. the air/fuel ratio for any given operating point of the internal combustion engine (e.g. internal combustion engine load and rotational speed). Hence e.g. various differ maps may be used and switched between in dependence of the desired result.

The above also applies to the exhaust residuals as control parameter, where, as explained, different amounts of exhaust residuals may be used as desired value for any given operating point of the internal combustion engine in dependence of the desired result to be achieved by the control.

Furthermore, according to embodiments of the invention, control of the opening of intake valve and closing of exhaust valve can be carried out on the basis of both air/fuel ratio and remaining exhaust residuals in said combustion chamber, so that control is performed simultaneously on the basis of both control parameters, where opening and closing of said intake valve and exhaust valve, respectively, are controlled such that actual values of both said control parameters are adjusted towards a desired value of said control parameters.

According to embodiments of the invention, the control of the opening of intake valve and closing of exhaust valve can be arranged to be carried out alternately on the basis of air/fuel ratio as control parameter and remaining exhaust residuals as control parameter, the particular control parameter to be used at any given point in time e.g. being selected in dependence on the current operating point of the internal combustion engine.

The system can preferably be designed/dimensioned so that an engine and turbocharger combination is chosen in such a way that the efficiency of a compressor of the turbocharger increases with increasing mass flow through the compressor and/or the turbine. This is of particular advantage when the engine is operating at low speed and high torque.

This design/dimensioning has the desired consequence that work needed to remove the exhaust gases is reduced so that the overall efficiency gain that is the result of reduced thermal losses in the combustion chamber increases. This is because the decrease in open cycle efficiency (efficiency when at least one valve is open, OCE) is smaller than it would otherwise be due to the dimensioning of the compressor. The gain in closed cycle efficiency (all valves closed, CCE) is larger than the OCE loss, resulting in an overall BTE increase.

According to embodiments of the invention, the internal combustion engine can be controlled according to various modes of operation. For example, the intake valve and exhaust valve can be controlled such that both valves are simultaneously open during a first period, which can be changed as an actual value is adjusted towards a desired value. The intake valve and exhaust valve may be controllable such that the exhaust valve closes prior to the intake valve opens.

According to embodiments of the invention, the period mentioned above can e.g. be a period of time but also e.g. a period represented by a crank shaft movement, e.g. a number of crank shaft degrees. Since the valves can be opened and closed at different positions of the piston in the combustion chamber, opening and closing can also be varied in relation to the crankshaft position (rotation).

Consequently, the difference in crank shaft degrees (i.e. rotation of the crank shaft) between opening of the intake valve in relation to the closing of the exhaust valve may also be varied, e.g. in dependence of the operation of the internal combustion engine.

According to embodiments of the invention, a first camshaft is used to control opening and closing of the exhaust valve, and a second camshaft is used to control opening and closing of the intake valve. Both the first and second camshaft can be arranged to be phase shifted (phased), e.g. using phasers, to accomplish control of the valves according to the above. That is, the camshafts can be arranged to comprise a degree of freedom of rotation independent from the rotation of the crankshaft. For example, the camshafts may be designed to allow a phasing corresponding e.g. to any suitable number of crank shaft degrees in the interval 10-100 degrees, where the phasing can be arranged to be both retarding and advancing in relation to crank shaft rotation.

According to embodiments of the invention, the valves are controlled using other suitable means. For example, the valves may be electrically controlled valves.

As in general is the case, the internal combustion engine may comprise a plurality of combustion chambers. Furthermore, the plurality of combustion chambers can be arranged to be divided into groups, or banks. For example, the combustion chambers may be divided into two banks, where the exhausts from each bank can be arranged to pass through separated exhaust manifolds.

According to embodiments of the invention, the internal combustion engine consists of an internal combustion engine without exhaust gas recirculation (EGR) from exhaust conduit to intake conduit.

According to embodiments of the invention, the compression-ignition internal combustion engine is, for example, an in-line six-cylinder internal combustion engine, where the cylinders are divided into two banks, each bank comprising a separate exhaust manifold.

According to embodiments of the invention, camshafts with increased symmetrical valve overlap may be utilized. That is, the valve-open period may be extended in relation to the camshaft normally used for a particular internal combustion engine. In this way exhaust valve opening (EVO) and intake valve closing (IVC) can be kept at similar crank axle degrees (CAD) positions as they would on a “normal” camshaft, while EVC may still be retarded and IVO be advanced resulting in increased valve overlap.

Further characteristics of the present invention and advantages thereof are indicated in the detailed description of exemplary embodiments set out below and the attached drawings.

### BRIEF DESCRIPTION OF THE DRAWINGS

FIG. 1A illustrates a power train of an exemplary vehicle in which the present invention advantageously can be utilized;

FIG. 1B illustrates an example of a control unit in a vehicle control system;

FIG. 2 illustrates an example of a combustion chamber suitable for being controlled according to embodiments of the invention.

FIG. 3A illustrates an exemplary method according to one embodiment of the present invention;

FIG. 3B illustrates a further exemplary method according to one embodiment of the present invention;

FIG. 4 illustrates an exemplary system involving an in-line six-cylinder internal combustion engine being controlled according to embodiments of the present invention; and

FIGS. 5A-E shows exemplary control strategies according to embodiments of the invention.

### DETAILED DESCRIPTION OF THE INVENTION

In the following detailed description, the present invention will be exemplified for a vehicle. The invention is, however, applicable also in other kinds of transportation means, such as air and watercrafts. The invention is also applicable in fixed installations. Further, the terms “intake valve” and “exhaust valve” are used to denote any means that open and close a passage to a combustion chamber for inlet of air and evacuation of combustion residuals, respectively.

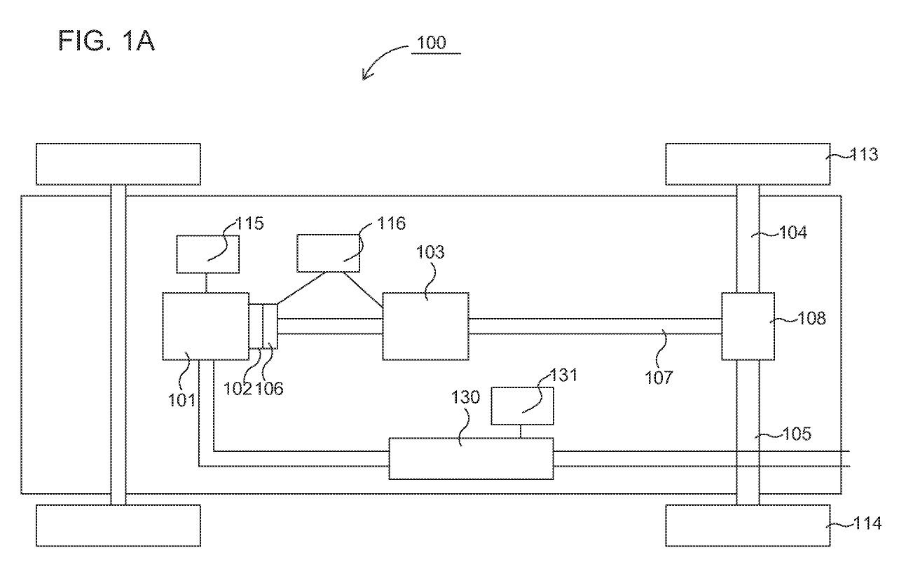

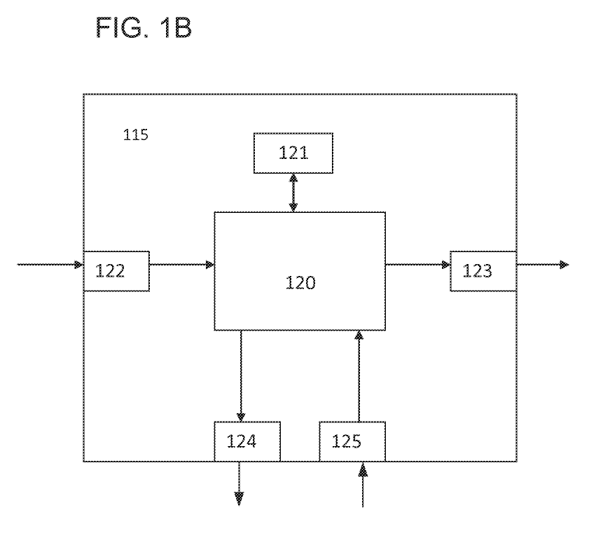

FIG. 1A schematically depicts a power train of an exemplary vehicle 100. The power train comprises a power source, in the present example a compression-ignited internal combustion engine 101 such as a Diesel engine, which, in a conventional manner, is connected via an output shaft of the internal combustion engine 101, normally via a flywheel 102, to a gearbox 103 via a clutch 106. An output shaft 107 from the gearbox 103 propels drive wheels 113, 114 via a final drive 108, such as a common differential, and drive axles 104, 105 connected to said final drive 108.

The internal combustion engine 101 is controlled by the vehicle control system via a control unit 115. The clutch 106 and gearbox 103 are also controlled by the vehicle control system by means of a control unit 116.

FIG. 1A discloses a powertrain of a specific kind, but the invention is applicable for any kind of power train, and also e.g. in hybrid vehicles. The disclosed vehicle further comprises aftertreatment components 130 for aftertreatment (purifying) of exhaust gases that results from combustion in the internal combustion engine 101. The functions of the aftertreatment components 130 are controlled by means of a control unit 131.

The aftertreatment components 130 may be of various kinds and designs. For example, in a manner known per se, the aftertreatment components 130 may include one or more from a diesel oxidation catalytic converter (DOC), which, inter alia, is used to oxidize remaining hydrocarbons and carbon monoxide in the exhaust gas stream. The oxidation can also be used to ensure that aftertreatment components downstream the oxidation catalytic converter 202 maintain a desired minimum temperature. The oxidation catalytic converter 202 may also oxidize nitrogen monoxides (NO) occurring in the exhaust gas stream to nitrogen dioxide (NO₂). This nitrogen dioxide is beneficial, for example, for increasing the efficiency of NOₓ reduction in SCR catalytic converters (see below) where reduction is dependent on the ratio between NO and NO₂ in the exhaust gas stream. Other reactions may also occur in the oxidation catalytic converter DOC 202.

Further, the aftertreatment components may include a diesel particulate filter DPF, e.g. arranged downstream an oxidation catalytic converter, and which basically has the task of collecting particles in the exhaust gas stream.

The aftertreatment components 130 may also comprise a selective catalytic reduction (SCR) catalytic converter, e.g. arranged downstream of the DPF. SCR catalytic converters in general reduce e.g. nitrous oxides NOₓ in the exhaust gas stream through the use of an additive in a manner known per se.

The aftertreatment components 130 may also include further and/or other elements, such as e.g. an ammonia slip catalytic converter ASC, which oxidizes surplus ammonia that may remain in the exhaust gases after passage through an SCR.

The components DOC, DPF, SCR catalytic converter, and ASC may, for example, be integrated in a single unit 130. Alternatively, the components can be arranged in any other suitable way manner, and one or more of said components can, for example, consist of separate units. Furthermore, the aftertreatment may include only one of said or other components or any combination of two or more components.

As was mentioned above, the present invention provides a method for controlling the combustion engine that, at least in some instances, may improve engine operation at least in some instance. For example, scavenging of residuals in the combustion chamber can be controlled and used to obtain desired operation of internal combustion engine and/or aftertreatment of exhaust gases, where e.g. exhaust gas temperature may be controlled. For example, operation of aftertreatment components of the kind described above, and perhaps in particular the SCR catalytic converter 204, are highly dependent on the prevailing temperature of the component. If the temperature of the component is too low, desired reactions may not occur and, conversely, if temperature is too high components may instead be damaged.

Embodiments of the present invention provides a method that may be used to influence the exhaust gas temperature of the exhaust gas entering aftertreatment components in a manner that is favourable to the temperature of the aftertreatment components. For example, the exhaust gas temperature can be arranged to be increased when combustion engine load is low by reducing the airflow through the engine. In addition, embodiments of the invention can, for example, be utilized to increase internal combustion engine efficiency at high engine loads.

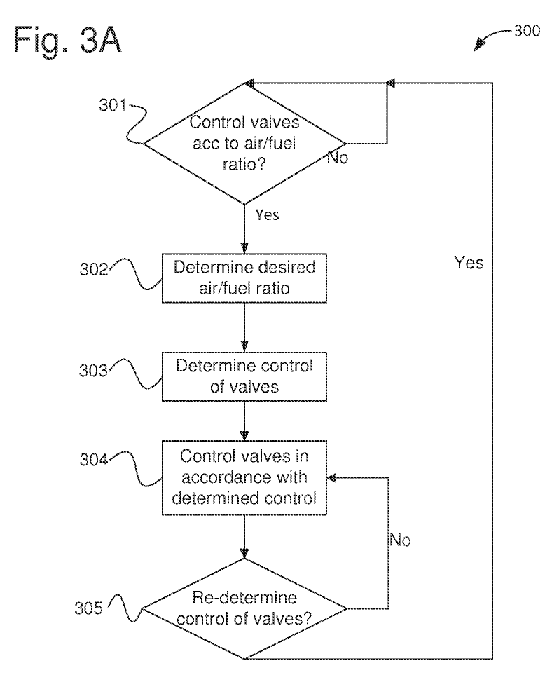

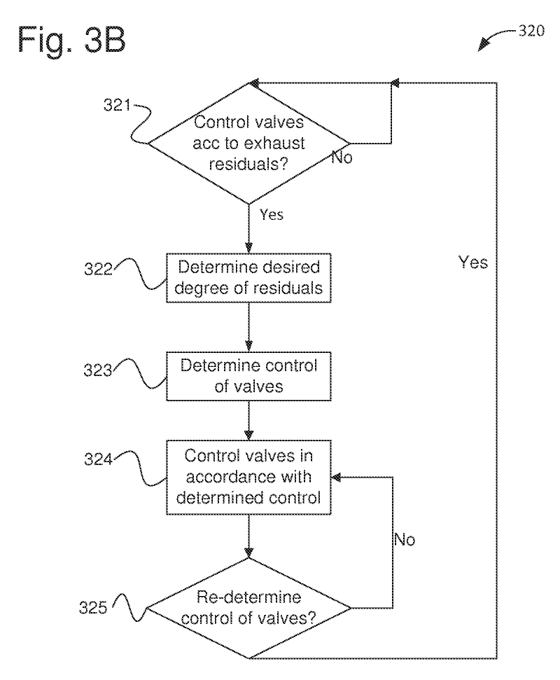

A first exemplary method 300 of the present invention is shown in FIG. 3. The method can be implemented at least partly e.g. in the engine control unit 115 for controlling operation of the internal combustion engine 101. The functions of a vehicle are, in general, controlled by a number of control units, and control systems in vehicles of the disclosed kind generally comprise a communication bus system consisting of one or more communication buses for connecting a number of electronic control units (ECUs), or controllers, to various components on board the vehicle. Such a control system may comprise a large number of control units, and the control of a specific function may be divided between two or more of them.

For the sake of simplicity, FIG. 1A depicts only control units 115-116, 131, but vehicles 100 of the illustrated kind are often provided with significantly more control units, as one skilled in the art will appreciate. Control units 115-116, 131 are arranged to communicate with one another and various components via said communication bus system and other wiring, partly indicated by interconnecting lines in FIG. 1A.

The present invention can be implemented in any suitable control unit in the vehicle 100, and hence not necessarily in the control unit 115. The control influencing the valve opening and valve closing according to the present invention will usually depend on signals being received from other control units and/or vehicle components, and it is generally the case that control units of the disclosed type are normally adapted to receive sensor signals from various parts of the vehicle 100. The control unit 115 may, for example, receive signals e.g. from the control unit 131 and various sensors with regard to the control of the internal combustion engine 101.

Control units of the illustrated type are also usually adapted to deliver control signals to various parts and components of the vehicle, e.g. to control intake valve and exhaust valve according to the invention, e.g. by controlling phasers of camshafts. Operation of vehicle control systems per se is known to the person skilled in the art.

Furthermore, control of this kind is often accomplished by programmed instructions. The programmed instructions typically consist of a computer program which, when executed in a computer or control unit, causes the computer/control unit to exercise the desired control, such as method steps according to the present invention. The computer program usually constitutes a part of a computer program product, wherein said computer program product comprises a suitable storage medium 121 (see FIG. 1B) with the computer program 126 stored on said storage medium 121. The computer program can be stored in a non-volatile manner on said storage medium. The digital storage medium 121 can, for example, consist of any of the group comprising: ROM (Read-Only Memory), PROM (Programmable Read-Only Memory), EPROM (Erasable PROM), Flash memory, EEPROM (Electrically Erasable PROM), a hard disk unit etc, and be arranged in or in connection with the control unit, whereupon the computer program is executed by the control unit. The behaviour of the vehicle in a specific situation can thus be adapted by modifying the instructions of the computer program.

An exemplary control unit (the control unit 115) is shown schematically in FIG. 1B, wherein the control unit can comprise a processing unit 120, which can consist of, for example, any suitable type of processor or microcomputer, such as a circuit for digital signal processing (Digital Signal Processor, DSP) or a circuit with a predetermined specific function (Application Specific Integrated Circuit, ASIC). The processing unit 120 is connected to a memory unit 121, which provides the processing unit 120, with e.g. the stored program code 126 and/or the stored data that the processing unit 120 requires to be able to perform calculations. The processing unit 120 is also arranged so as to store partial or final results of calculations in the memory unit 121.

Furthermore, the control unit 115 is equipped with devices 122, 123, 124, 125 for receiving and transmitting input and output signals, respectively. These input and output signals can comprise waveforms, pulses or other attributes that the devices 122, 125 for receiving input signals can detect as information for processing by the processing unit 120. The devices 123, 124 for transmitting output signals are arranged so as to convert calculation results from the processing unit 120 into output signals for transfer to other parts of the vehicle control system and/or the component (s) for which the signals are intended. Each and every one of the connections to the devices for receiving and transmitting respective input and output signals can consist of one or more of a cable; a data bus, such as a CAN bus (Controller Area Network bus), a MOST bus (Media Oriented Systems Transport) or any other bus configuration, or of a wireless connection.

Returning to the exemplary method 300 illustrated in FIG. 3, this method relates to control on the basis of a control parameter constituting an air/fuel ratio. The method starts in step 301, where it is determined whether intake valve and exhaust valve are to be controlled according to a desired air/fuel ratio. The method remains in step 301 for as long as this is not the case. The method continues to step 302 when it is determined that the valves are to be controlled according to the invention. The transition from step 301 to step 302 can, for example, be initiated according to various criteria. For example, the control can be arranged to be performed at all times, i.e. always when the internal combustion engine is started/in operation. Alternatively, control according to the invention can be arranged to be performed e.g. when certain conditions are fulfilled, e.g. with regard to vehicle internal operational conditions. Such conditions may, for example, relate to the current load of the internal combustion engine or one or more temperatures prevailing in the aftertreatment system. Other criteria for performing the transition from step 301 to step 302 may also be applied.

In step 302 a desired value of the air/fuel ratio is determined. This desired air/fuel ratio may be a global air/fuel ratio constituting a combination of the local air/fuel ratio prevailing in the combustion chamber, and air that may be flushed through the combustion chamber in situations when intake valve and exhaust valve are simultaneously open. The global air/fuel ratio, in the following only denoted air/fuel ratio, may be determined e.g. by a suitable sensor in the exhaust gas stream and/or be determined through model representation. The air/fuel ratio may also be determined e.g. through the use of a table comprising empirical measurements. The global air/fuel ratio may be used to determine the local air/fuel ratio in the combustion chamber, e.g. through knowledge of flow of air through the open valves, which can be determined in a straightforward manner, e.g. through the use of a pressure difference over the combustion chamber. Hence a local air/fuel ratio can be determined using a global air/fuel ratio, or e.g. by measuring air/fuel ratio directly in the combustion chamber using a sensor.

When it is determined that the temperature of one or more components in the aftertreatment system is lower than preferred it may be desirable to increase the temperature of the exhaust gas stream. This can be performed by reducing the desired air/fuel ratio, i.e. it is desired that less air is provided to the combustion chamber. Hence the desired air/fuel ratio can be changed. The desired air/fuel ratio can be changed to a value determined e.g. as above, and/or on the basis of a feedback loop, where e.g. one or more temperatures in the system, such as one or more temperatures regarding the aftertreatment components, can be used when determining suitable change of the desired value. Control of the actual air/fuel ratio can then be e.g. reduced by advancing closing of the exhaust valve, i.e. closing the exhaust valve for an earlier position of the reciprocating member in the combustion chamber and/or retarding opening of the intake valve in relation to said position of the reciprocating member, i.e. delaying opening of the intake valve.

Another example according to the invention is when internal combustion engine load is high. In this case air/fuel ratio prevailing in the combustion chamber may become too low with the result that heat losses increase and engine efficiency thereby decreases. According to the invention, the local air/fuel ratio in the combustion chamber can be increased by increasing the global air/fuel ratio, which in turn can be increased by retarding closing of the exhaust valve and/or advancing opening of the intake valve so that e.g. the exhaust valve and intake valve are simultaneously open, or opened for a longer period of time if already being controlled such that they are simultaneously open, to thereby increase the amount of air passing through the system.

In step 303 a suitable control of the intake valves and exhaust valves to control an actual value of the air/fuel ratio towards the desired value of the air/fuel ratio is determined. This control may hence comprise control of at least EVC, i.e. exhaust valve closing, and IVO, i.e. intake valve opening, where e.g. empirical measurements and/or a lookup table and/or a model presentation can be used to determine a control of the intake valve and/or exhaust valve in dependence on the desired value of the air/fuel ratio so as to adjust an actual air/fuel ratio towards the desired air/fuel ratio.

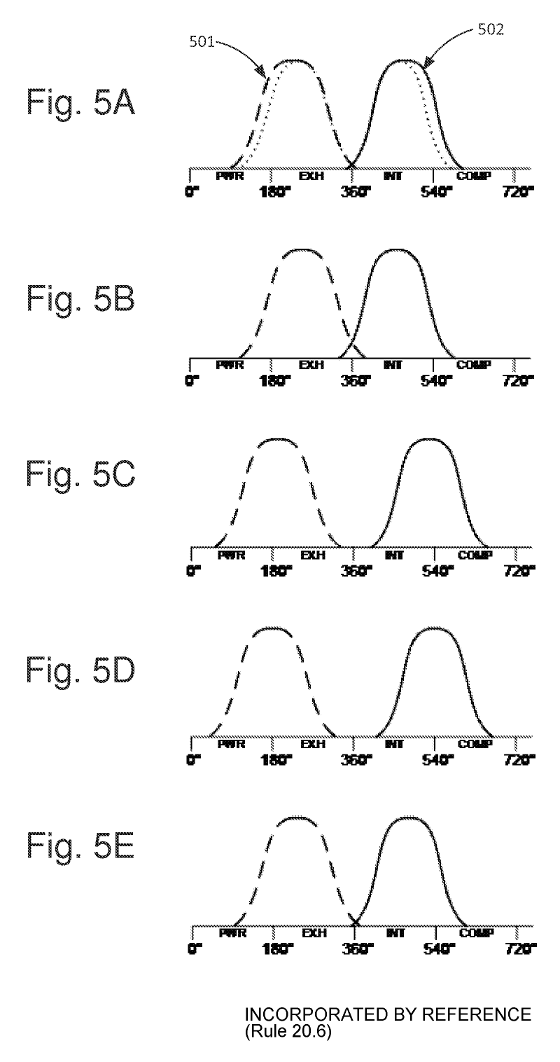

Following a description of an exemplary system, examples of control according to the above will be discussed below with reference to FIG. 5A-E.

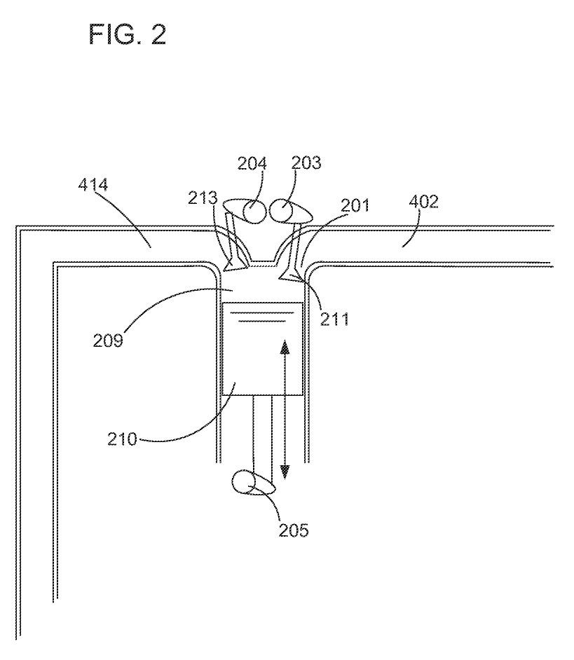

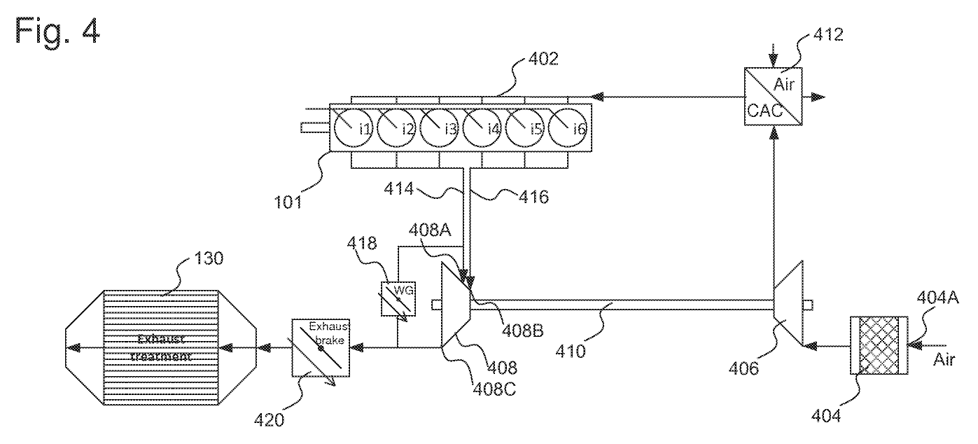

An exemplary combustion chamber 209 is shown in FIG. 2. The figure discloses only one cylinder/combustion chamber 209 in which a reciprocating piston is arranged 210. As will be shown in FIG. 4, the combustion engine 101 according to the present example constitutes an in-line six-cylinder internal combustion engine. The present invention may be utilized for combustion engines having any number of combustion chambers.

Internal combustion engines of the disclosed kind further comprises, in general, at least one fuel injector per combustion chamber (not shown) which in a conventional manner supplies fuel to the combustion chamber for combustion.

The combustion chamber 209 comprises an inlet 201 being controlled by one or more intake valves 211, which may be arranged to be individually controlled in relation to an exhaust valve 213 according to the below. Air for combustion is supplied to the combustion chamber by means of the intake valve 211 through an intake conduit 402, e.g. consisting of suitable piping, tubing and/or hosing, for receiving the air for supply to the combustion. In general, the air consists of air taken from the environment of the vehicle.

Evacuation of the combustion chamber 209 is controlled through an (or a plurality of) exhaust valve 213, which opens towards an exhaust manifold 414.

With regard to the exhaust valve 213 and intake valve 211 these are, in the present example, controlled individually by means of camshafts 203, 204, respectively, which, although being commonly driven by a crankshaft 205, are arranged to be individually phased in relation to each other so that opening time, closing time and possibly duration of the opening of the valves 211, 213 can be individually controlled for each valve. The phasing can, for example be accomplished by means of phasers. Use of phasers allows continuous adjustment of the valve control. For example, the phasers may be arranged such that each camshaft can be phase shifted up to e.g. 60, 80 or 100 crank angle degrees or any other suitable number of degrees, where phase shifting can selectively be e.g. both advancing and retarding, thereby allowing a relatively high degree of freedom when controlling the intake valve and exhaust valve in relation to each other.

The system is also shown in FIG. 4, which schematically shows all cylinders of the combustion engine, denoted i1-i6 in FIG. 4.

According to the disclosed example, ambient air from the vehicle/engine surrounding is drawn trough an air filter 404 from an intake side 404A of the air filter 404 being subjected to ambient air and being drawn through the air filter 404 by means of a compressor 406. The compressor 406 is driven by a turbine 408, the compressor 406 and turbine 408 being interconnected by means of a shaft 410, thereby forming a conventional turbocharger. The compressed air is cooled by a charge air cooler 412 in a manner known per se prior to being supplied to the intake conduit 402 and combustion chambers i1-i6 of the internal combustion engine 101.

Passage to the exhaust conduits of the combustion chambers i1-i6, are controlled by the exhaust valves of the combustion chambers, respectively. The exhaust conduits are further arranged such that exhaust gases emanating from cylinders i1-i3 share a common conduit 414 from exhaust outlets to a first inlet 408A of the turbine 408. Correspondingly, exhaust gases emanating from cylinders i4-i6 share a common conduit 416, separate from the conduit 414, from exhaust outlets to a second inlet 408B of the turbine 408. The turbine 408, consequently, comprises separate exhaust gas inlets for receiving the exhaust gas streams from conduits 414 and 416, respectively, e.g. constituting a conventional twin-scroll turbine.

The turbine 408 further constitutes a fixed geometry turbine, and a waste gate 418 is connected to either or both conduits 414, 416 for turbine bypass when required. An arrangement of this kind, i.e. an arrangement where separate exhaust conduits are used for each bank of combustion chambers, has the advantage that the pressure pulse consisting of exhaust from one combustion chamber will reduce and/or eliminate the interference from the operation of another combustion chamber. If all six cylinders had been evacuated through a common exhaust conduit emanating close to the exhaust outlets of the combustion chambers, respectively, a pressure pulse when e.g. combustion chamber i4 opens to evacuate exhaust gases may travel and reach e.g. combustion chamber i1 at the time when this combustion chamber opens the exhaust valve. If in this situation the intake valve and exhaust valve of the combustion chamber i1 are simultaneously open, the exhaust pulse may pass through combustion chamber i1 to the inlet side of the internal combustion engine 101. Such flow of exhaust gases is highly undesirable and can be avoided by separating the exhaust passages by dividing the combustion chambers into separate banks sharing separate exhaust manifolds, e.g. according to the present example.

The exhaust gas stream is then again combined and discharged by the turbine 408 through a single common outlet 408C and is led, in the present example via an exhaust brake 420, to the one or more aftertreatment components 130 for aftertreatment of exhaust gases according to the above prior to being released into the surroundings of the vehicle 100. According to the disclosed embodiment, an SCR catalytic converter is in itself capable of reducing nitric oxides to a desired extent and hence no further reduction is required. That is, no EGR recirculation is required. Systems of this kind may provide an additional degree of freedom in controlling the internal combustion engine, since EGR requirements regarding pressure differences between intake side and exhaust side of the internal combustion engine need not be accounted for.

As was mentioned above, a suitable control of the intake valves and exhaust valves is determined in step 303 on the basis of the difference between the actual value of the air/fuel ratio, or other suitable control parameter such as remaining exhaust residuals as discussed below, and the desired value of air/fuel ratio (desired value of the control parameter). FIGS. 5A-E shows exemplary control methods that may be utilized according to the invention. The y-axis represent state of the valve, where the zero level represents a fully closed valve, and the other levels at least partially open valve, where physically fully open occurs at the top of the curve, but the fully open position in terms of flow may occur earlier. According to the invention, the valves are considered “open” when they are not fully closed, i.e. as soon as they have started to open and until they again are in closed position. The x-axis represent movement, expressed in crankshaft degrees and 0, 360, 720 representing piston position TDC.

Furthermore, according to embodiments of the invention, camshafts are used that have a prolonged opening time in comparison to conventional camshafts. This is not a requirement according to the invention, but in addition to the individually controllable cam phasing, this provides additional advantages and possibilities in the control of the opening and closing of the intake and exhaust valves. This is illustrated in FIG. 5A below.

When a suitable control has been determined in step 303, e.g. according to any of the examples disclosed in FIGS. 5A-E or any other suitable control, the method continues to step 304 where the control is commenced by operating, in this case phasing, the camshafts 203, 204 in accordance with the control determined in step 303 to obtain the desired operation of the exhaust valve and intake valve. According to embodiments of the invention, the valves of all combustion chambers are simultaneously controlled by the camshafts operating all valves in a conventional manner.

It may then be determined whether the control is to be determined anew, e.g. due to changed or changing operating conditions, in which case the method returns to step 301. Otherwise the method returns to step 304 to continue control according to determined parameters. As driving conditions and/or internal combustion engine load may continuously vary, the control may also be arranged to continuously vary, and also e.g. in dependence of feedback signals e.g. in the form of the actual air/fuel ratio. According to the invention, consequently, the valves can be arranged to be continuously controlled to account for changes in a desired air/fuel ratio and/or changes in prevailing conditions that require further control of the intake and/or exhaust valves to obtain the desired air/fuel ratio.

FIG. 5A-E illustrates exemplary control strategies, and in FIG. 5A exemplary “normal” cam profiles are shown in dotted lines, which, according to exemplary embodiments of the invention, are replaced by cam profiles with longer duration. This is represented by dashed (exhaust valve) and solid (intake valve) lines. Consequently, as can be seen from FIG. 5A, if exhaust valve 501 closing and intake valve 502 opening take place at a particular position, camshafts providing extended opening times will result in the exhaust valve opening earlier, and the intake valve closing later. The opening times of the “normal” cam profiles may be 190-195, e.g. 193, crank shaft degrees for the intake valve, and 200-205, e.g. 204, crank shaft degrees for the exhaust valves. The opening times of according to embodiments of the invention may be 203-215, e.g. 213, crank shaft degrees for the intake valve, and 210-225, e.g. 224, crank shaft degrees for the exhaust valves.

FIG. 5B shows an example of an exemplary resulting valve control when it is determined in step 303 that air/fuel ratio is to be increased in order e.g. to reduce heat loss in the combustion chambers so as to increase efficiency of the internal combustion engine. According to FIG. 5B, the intake valve and exhaust valve are controlled such that there is an exhaust valve/intake valve overlap at TDC 360°, at present both camshafts are phased approximately 15° toward more overlap, i.e. being phased in opposite directions where the exhaust camshaft is retarded and the intake camshaft is advanced, to thereby obtain a total increased overlap of approximately 30° so that intake air is allowed to pass through the combustion chamber and directly to the outlet to improve evacuation of the exhausts. In this way, the global air/fuel ratio is increased, and thereby also the local air/fuel ratio in the combustion chamber during combustion, so that heat losses are reduced and engine efficiency increased. In dependence on the particular air/fuel ratio being requested, and current operating conditions, the valve overlap may be arranged to continuously vary to obtain as result the desired air/fuel ratio.

In addition, as was mentioned the valve overlap is accomplished by retarding the camshaft controlling the exhaust valve, while simultaneously advancing the camshaft controlling the intake valve. According to the particular example, the advancing/retarding corresponds to the extended valve duration according to FIG. 5A, i.e. approx. 15°, which has the result that the exhaust valve still opens at the “normal” position, and the intake valve closes at the “normal” position. This however, will oftentimes not be the case, and as was mentioned, the invention is also equally applicable for conventional camshafts without prolonged valve open times. According to the disclosed example, the phasing is symmetrical, i.e. both camshafts are phase shifted to an equal extent albeit in different directions. This, however, need not be the case and the camshafts may be phased to different extents. Also, since conditions may continuously vary, e.g. with regard to driving resistance of the vehicle, the phasing may be continuously varying and/or phasing of the camshafts be varying independently from each other. The passage of intake air to the exhaust side reduces exhaust temperature, which may also be beneficial to e.g. temperature sensitive aftertreatment components.

FIG. 5C discloses an example of valve control which can be utilized when it is determined in step 303 that exhaust gas temperature is low and air/fuel ratio hence should be reduced in order to increase exhaust gas temperature, e.g. at low engine load. According to this example, the camshafts are each phased approx. 45° towards a negative overlap, i.e. the exhaust cam shaft is advanced so that the exhaust valve closes earlier while the intake camshaft is retarded and the intake valve hence opens at a later point during the intake stroke. According to FIG. 5C, the exhaust valve closes well before the intake valve opens and this kind of control can hence be utilized to reduce air/fuel ratio, also oftentimes denoted lambda, A, and also exhaust flow to thereby increase exhaust temperature.

FIG. 5D shows an exemplary maximum phasing of, according to the present example, approximately 55°/55°. Maximum phasing may be beneficial to use e.g., when the vehicle is coasting, in particular when coasting with the engine rotating and the transmission in gear without fuel supply. During coasting cold air will be flushed through the engine without undergoing substantially any heating and thereby subject the aftertreatment components to substantial cooling. The use of maximum negative phasing can be used to minimize flow across the engine to thereby as much as possible maintain the temperature of the exhaust treatment system. If the intake valve is open through most or all of the compression stroke the flow through the engine can be reduced to essentially zero. According to the invention, valve control may be arranged to continuously vary between the cam phasing extreme positions and any position there in between, and also asymmetrically, in dependence on the determined desired value of the air/fuel ratio.

FIG. 3B discloses a further exemplary method 320 according to the invention. This method is similar to the method in FIG. 3A, however with the difference that the internal combustion engine is, instead, controlled on the basis of a control parameter relating to the exhaust residual content in the combustion chambers following a combustion cycle. The method starts in step 321, where it is determined whether intake valve and exhaust valve are to be controlled according to exhaust residual content in the combustion chamber, e.g. a remaining portion of exhaust residuals. The method remains in step 321 for as long as this is not the case. The method continues to step 322 when it is determined that the valves are to be controlled according to the invention, where the transition may be as above. The control of the internal combustion engine on the basis of exhaust residuals may be used in a highly similar manner as when controlling on the basis of air/fuel ratio.

In step 322, therefore, a desired value of the exhaust residuals is determined. This desired value may e.g. be a remaining proportion of the exhaust gases formed during a combustion cycle, the rest of which being evacuated.

A representation of the exhaust residuals may e.g. be determined through the use of a model representation, or from measurements in the exhaust gas stream, e.g. by determining mass flow and/or one or more temperatures. The remaining exhaust residuals may also be determined e.g. through the use of a table comprising empirical measurements.

Control according to exhaust residuals can be performed much as described above. For example, when it is determined that the temperature of one or more components in the aftertreatment system is lower than preferred it may be desirable to increase the temperature of the exhaust gas stream, which can be accomplished by increasing the exhaust gas residuals, so that, in a following combustion cycle the combustion gas to a higher extent consists of exhaust gas residuals from the preceding combustion cycle and less of fresh air. This can be accomplished by advancing closing of the exhaust valve, and/or retarding opening of the intake valve in relation to said position of the reciprocating member. Hence, when cam phasing is utilized, the cam shafts can be controlled/adjusted towards a position of the kind disclosed in FIG. 5C, i.e. overlap is reduced when overlap in opening time is present and/or a period between closing of the exhaust valve and opening of the intake valve can be increased.

Conversely, when internal combustion engine load is high, as was mentioned above, air/fuel ratio prevailing in the combustion chamber may become too low with the result that heat losses increase. This is alleviated by reducing exhaust gas residuals so that a larger portion of colder air can be supplied to the combustion chambers. However, if too high amounts of air are allowed to flush through the combustion chambers when exhaust valve and intake valve are simultaneously open, pump losses are imposed instead. This can be controlled by controlling exhaust gas residuals by suitable retarding/advancing of the closing of the exhaust valve and/or advancing/retarding opening of the intake valve so that e.g. a suitable amount or air is allowed to pass through the combustion chamber during scavenging. Hence, control towards FIG. 5B can be performed in this case.

In step 323 a suitable control of the intake valves and exhaust valves to control an actual value of the exhaust gas residuals towards the desired value of the exhaust gas residuals. The control can be arranged to be continuously adjusted as described above.

The invention, consequently, provides methods for controlling internal combustion engine operation by controlling timing of exhaust and intake valve opening/closing. The invention may be combined with further features that may be achieved using controllable valves according to the above. FIG. 5E exemplifies this and shows essentially the phasing of FIG. 5A, where EVO and IVC are controlled such that there is essentially no overlap, but where the extended valve-open durations instead result in early exhaust valve opening (EEVO) and late intake valve closing (LIVC). This kind of phasing, where the camshafts are phased toward to conventional EVO and IVC may be utilized e.g. at medium to high engine speed position to improve, inter alia, brake thermal efficiency (BTE). The combination of LIVC+EEVO is beneficial. EEVO increases the time-window available to evacuate the exhaust gases and according to the disclosed example the exhaust valve opens already during the power stroke. Consequently, the pressure in the cylinder is lower when the piston reaches bottom dead centre (BDC) and starts its upward exhaust stroke making this stroke less power consuming, i.e. increasing open cycle efficiency, OCE.

LIVC, in turn, reduces mass flow through the engine, which reduces pumping work and increases OCE. Because of higher engine speed the time available for heat loss is shorter and since air/fuel ratio lambda A is sufficiently high the loss in closed cycle efficiency, CCE, due to less bulk mass is smaller than the OCE gain.

Furthermore, the examples shown in FIGS. 5A-E discloses an additional feature that may or may not be utilized, and which may be utilized to different extents through control of in particular the intake valve. As can be seen from the figure, the intake valve closes after the piston has reached BDC, and hence after the compression stroke is commenced. This means that as the piston moves upwards in the compression stroke while the intake valve is still open the charge is partially expelled back into the intake manifold through the open intake valve. The use of such control in combination with supercharged intake air is called Miller-cycle. Operation according to the Miller-cycle may be advantageous. For example, the Miller-cycle may be utilized to “reduce” the effective volume of the combustion chamber by creating a virtual BDC at a position between actual BDC and TDC, so that the engine appears smaller than actually is the case. In this way, the same hardware may be used to be operated as engines having different cylinder volumes, i.e. the full capacity of the engine need not be utilized.

The invention may also benefit from further control of intake valves and/or exhaust valves, and may be combined with further features disclosed in the parallel Swedish patent application “METHOD AND SYSTEM FOR CONTROLLING AN INTERNAL COMBUSTION ENGINE” having the same inventors and filing date as the present application. This application discloses further features of varying the closing of the exhaust valve and opening of the intake valve in relation to a reciprocating member in a combustion chamber, which features may be combined with the present invention.

In addition to the above, the present invention may also be used in combination with the solutions described in the Swedish patent application 1550976 Title “METHOD AND SYSTEM FOR CONTROLLING EXHAUST GASES RESULTING FROM COMBUSTION” and Swedish patent application 1550978, title “METHOD AND SYSTEM FOR CONTROLLING AN INTERNAL COMBUSTION ENGINE”.

SE1550976 relates to situations where undesired temperatures may arise. According to SE1550976, exhaust gas temperatures are controlled by a method (and system) by means of which air from the intake side of the internal combustion engine is arranged to bypass the combustion chambers for mixing with the exhaust gases when hot exhaust gases are expected. In this way, hot exhaust gases can be cooled off in situations when hot exhaust gases may damage temperature sensitive components.

Furthermore, at least part of exhaust gases resulting from said combustion are recirculated uncooled to said intake side when the temperature is such that exhaust gases may otherwise cool off aftertreatment components to an extent where proper operation no longer can be ensured.

EGR like circuitry can be used to effect circulation according to the above, where only gases from combustion chambers in which no combustion has been carried out can be recirculated.

SE1550978 relates to situations where it might be difficult to maintain an exothermic, i.e. temperature increasing, reaction in, for example, an oxidation catalyst that is used to oxidize remaining unburned fuel in the exhaust gases.

According to SE1550978, an exothermic reaction is upheld when cold exhaust gases may cool off aftertreatment components. This is accomplished by supplying unburned fuel to exhaust gases discharged by some combustion chambers through fuel injection into only part of the combustion chambers of a combustion engine.

Furthermore, at least part of exhaust gases discharged by combustion chambers being distinct from the combustion chambers into which fuel is injected are recirculated to the intake side of the internal combustion engine, where the exhaust gases are being recirculated at least substantially uncooled.

The solutions provided by the present invention may be combined with the solution described in said applications e.g. to enhance further operation of the internal combustion engine.

Finally, the present invention has been exemplified for a vehicle. The invention is, however, applicable in any kind of craft, such as, e.g., aircrafts and watercrafts. The invention is also applicable for use in combustion plants.

1. A method for controlling a compression-ignition internal combustion engine, said internal combustion engine having at least one combustion chamber, wherein intake of air to said combustion chamber is controlled using an intake valve, and wherein evacuation of said combustion chamber is controlled using an exhaust valve, wherein the method comprises:
controlling opening of said intake valve and closing of said exhaust valve in dependence of the position of a reciprocating member in said combustion chamber, wherein, opening of said intake valve and closing of said exhaust valve, respectively, in relation to the position of said reciprocating member is individually controllable;
controlling opening and closing in relation to the position of said reciprocating member on the basis of a first control parameter, wherein said opening and closing of said intake valve and exhaust valve, respectively, are controlled such that an actual value of said control parameter is adjusted towards a desired value of said control parameter, said first control parameter being an air/fuel ratio or a representation of remaining exhaust residuals in said combustion chamber; and
in one mode of operation, controlling closing of said exhaust valve and opening of said intake valve, respectively, on the basis of said control parameter such that both said valves are simultaneously open during a period of variable length, so that intake air passes through the combustion chamber and simultaneously mixes with and evacuates exhaust residuals.

2. A method according to claim 1, further comprising:
controlling said exhaust valve and said intake valve such that closing of said exhaust valve and opening of said intake valve, respectively, are performed in a variable dependence of a position of said reciprocating member in said combustion chamber.

3. A method according to claim 1, further comprising, when an exhaust gas temperature is to be increased:
control the desired value of said control parameter such that when controlling an actual value of said control parameter towards said desired value, closing of said exhaust valve is advanced and/or opening of said intake valve is retarded in relation to the position of the reciprocating member in said combustion chamber.

4. A method according to claim 1, further comprising, when the fuel efficiency of said internal combustion engine is to be increased:
control the desired value of said control parameter such that when controlling an actual value of said control parameter towards said desired value the opening of said intake valve is advanced and/or closing of said exhaust valve is retarded in relation to the position of the reciprocating member in said combustion chamber.

5. A method according to claim 1, said first control parameter being an air/fuel ratio, said method further comprising:
determining an actual air/fuel ratio, and
when said actual fuel ratio differs from a desired air/fuel ratio, controlling closing of said exhaust valve and/or opening of said intake valve such that said actual air/fuel ratio is adjusted towards said desired air/fuel ratio.

6. A method according to claim 5, further comprising:
when said determined air/fuel ratio is below said desired air/fuel ratio, retard closing of said exhaust valve and/or advance opening of said intake valve in relation to the position of said reciprocating member in said combustion chamber, and/or
when said determined air/fuel ratio is above said desired air/fuel ratio, advance closing of said exhaust valve and/or retard opening of said intake valve in relation to the position of said reciprocating member in said combustion chamber.

7. A method according to claim 5, further comprising, determining said desired air/fuel ratio as an air/fuel ratio taking into account passage of air through said combustion chamber when both said exhaust valve and said intake valve are simultaneously open.

8. A method according to claim 1, said first control parameter being a representation of remaining exhaust residuals in said combustion chamber, the method further comprising:
when the actual exhaust residuals differ from desired exhaust residuals, controlling closing of said exhaust valve and/or opening of said intake valve, such that said actual exhaust residuals are adjusted towards said desired exhaust residuals.

9. A method according to claim 8, further comprising,
when an exhaust gas temperature is to be increased, control the desired value of remaining exhaust residuals such that the desired exhaust residuals increase, and control the actual value of said exhaust residuals towards said desired value, and/or
when the efficiency of said internal combustion engine is to be increased, control the desired value of remaining exhaust residuals such that the desired exhaust residuals reduce, and control the actual value of said exhaust residuals towards said desired value.

10. A method according to claim 1, further comprising:
controlling opening of said intake valve and closing of said exhaust valve on the basis of both a first and a second control parameter, one of said first and second control parameters being an air/fuel ratio and the other of said first and second control parameters being a representation of remaining exhaust residuals in said combustion chamber, wherein said opening and closing of said intake valve and exhaust valve, respectively, are controlled such that actual values of both said control parameters are adjusted towards a desired value of said control parameters.

11. A method according to claim 1, wherein the position of the reciprocating member in the combustion chamber is represented by a crank shaft position, wherein a crank shaft degree at which an intake valve opens, and a crank shaft degree at which the exhaust valve closes can be controlled.

12. A method according to claim 1, wherein a first camshaft is used to control opening and closing of said exhaust valve, and a second camshaft is used to control opening and closing of the intake valve.

13. A method according to claim 12, wherein opening of said intake valve and closing of said exhaust valve are controlled by individually phasing said first and second cam shaft.

14. A method according to claim 13, further comprising:
individually phasing said camshafts any number of crank shaft degrees in an interval of 10-100 degrees.

15. (canceled)

16. A computer program product stored on a non-transitory computer-readable medium, said computer program product for controlling a compression-ignition internal combustion engine, said internal combustion engine having at least one combustion chamber, wherein intake of air to said combustion chamber is controlled using an intake valve, and wherein evacuation of said combustion chamber is controlled using an exhaust valve, said computer program product comprising computer instructions to cause one or more electronic control units or computers to perform the following operations:
controlling opening of said intake valve and closing of said exhaust valve in dependence of the position of a reciprocating member in said combustion chamber, wherein, opening of said intake valve and closing of said exhaust valve, respectively, in relation to the position of said reciprocating member is individually controllable;
controlling opening and closing in relation to the position of said reciprocating member on the basis of a first control parameter, wherein said opening and closing of said intake valve and exhaust valve, respectively, are controlled such that an actual value of said control parameter is adjusted towards a desired value of said control parameter, said first control parameter being an air/fuel ratio or a representation of remaining exhaust residuals in said combustion chamber; and
in one mode of operation, controlling closing of said exhaust valve and opening of said intake valve, respectively, on the basis of said control parameter such that both said valves are simultaneously open during a period of variable length, so that intake air passes through the combustion chamber and simultaneously mixes with and evacuates exhaust residuals.

17. A system for controlling a compression-ignition internal combustion engine, said internal combustion engine having at least one combustion chamber wherein intake of air to said combustion chamber is controlled using an intake valve, and wherein evacuation of said combustion chamber is controlled using an exhaust valve, the system comprising:
control means adapted to control opening of said intake valve and closing of said exhaust valve in dependence of the position of a reciprocating member in said combustion chamber, wherein opening of said intake valve and closing of said exhaust valve, respectively, in relation to the position of said reciprocating member is adapted to be individually controllable;
control means adapted to control opening and closing of said valves in relation to the position of said reciprocating member on the basis of a first control parameter, wherein said opening and closing of said intake valve and exhaust valve, respectively, are controlled such that an actual value of said control parameter is adjusted towards a desired value of said control parameter, said first control parameter being an air/fuel ratio or a representation of remaining exhaust residuals in said combustion chamber; and
control means adapted to control closing of said exhaust valve and opening of said intake valve, respectively, on the basis of said control parameter such that both said valves are simultaneously open during a period of variable length, so that intake air passes through the combustion chamber and simultaneously mixes with and evacuates exhaust residuals.

18. A system according to claim 17, wherein the engine and turbocharger combination is designed such that the efficiency of a compressor of the turbocharger increases with increasing mass flow through the compressor and/or a turbine of the turbocharger.

19. A system according to claim 17, wherein the internal combustion engine consists of an internal combustion engine without exhaust gas recirculation (EGR) conduit for recirculating exhausts from exhaust conduit to intake conduit.

20. A vehicle comprising a system for controlling a compression-ignition internal combustion engine, said internal combustion engine having at least one combustion chamber, wherein intake of air to said combustion chamber is controlled using an intake valve, and wherein evacuation of said combustion chamber is controlled using an exhaust valve, the system comprising:
control means adapted to control opening of said intake valve and closing of said exhaust valve in dependence of the position of a reciprocating member in said combustion chamber, wherein opening of said intake valve and closing of said exhaust valve, respectively, in relation to the position of said reciprocating member is adapted to be individually controllable;
control means adapted to control opening and closing of said valves in relation to the position of said reciprocating member on the basis of a first control parameter, wherein said opening and closing of said intake valve and exhaust valve, respectively, are controlled such that an actual value of said control parameter is adjusted towards a desired value of said control parameter, said first control parameter being an air/fuel ratio or a representation of remaining exhaust residuals in said combustion chamber; and
control means adapted to control closing of said exhaust valve and opening of said intake valve, respectively, on the basis of said control parameter such that both said valves are simultaneously open during a period of variable length, so that intake air passes through the combustion chamber and simultaneously mixes with and evacuates exhaust residuals.
